(19) United States
(12) Patent Application Publication
(10) Pub. No.: US 2006/0238966 A1
(43) Pub. Date: Oct. 26, 2006

(54) Monitor

(76) Inventor: Ki-hyub Sung, Suwon-si (KR)

Correspondence Address: STANZIONE & KIM, LLP, 919 18TH STREET, N.W., SUITE 440, WASHINGTON, DC, 20006, US

(21) Appl. No.: 11/316,825

(22) Filed: Dec. 27, 2005

(30) Foreign Application Priority Data
Apr. 21, 2005 (KR) 2005-33185

(51) Int. Cl. G06F 1/16

(52) U.S. Cl. 361/681; 248/918

(57) ABSTRACT

The invention relates to a monitor that includes a main body to display an image, a base member, a link member having a first end tiltably coupled with a main body hinge provided with respect to the monitor main body and a second end tiltably coupled with a base hinge provided with respect to the base member; a main body bracket to tiltably couple the monitor main body with the main body hinge; and a lifting unit provided between the monitor main body and the main body bracket to support the monitor main body so that it may be lifted up and down with respect to the main body bracket.

### CROSS-REFERENCE TO RELATED APPLICATION

This application claims the benefit of Korean Patent Application No. 10-2005-0033185, filed on Apr. 21, 2005, in the Korean Intellectual Property Office, the disclosure of which is incorporated herein by reference.

### BACKGROUND OF THE INVENTION

1. Field of the Invention

The invention relates to a monitor, and more particularly, to a monitor having improved tilting and lifting configurations for a monitor main body with respect to a base member.

2. Description of the Related Art

Generally, a monitor includes a base member that is seated on a predetermined surface, and a main body that is tiltably supported by the base member to display an image.

Such a conventional monitor is disclosed in Korean Patent Application No. 2002-41617. Here, the conventional monitor includes a monitor main body to display an image; a base member to support the monitor main body; a link member having a first end tiltably coupled with a main body hinge provided with respect to the monitor main body and a second end tiltably coupled with a base hinge provided with respect to the base member; an auxiliary link member which is coupled with the main body hinge and the base hinge in a position that is eccentric to axes of the main body hinge and the base hinge to transmit a tilting movement of the link member with respect to the base member to a tilting movement of the monitor main body with respect to the link member; a main body bracket which is disposed between the monitor main body and the link member; and a pivoting unit to connect the monitor main body and the main body bracket to pivot the monitor main body with respect to the main body bracket.

Thus, the monitor main body of the conventional monitor tilts around the axes of the main body hinge and the base hinge in leftward and rightward directions of the monitor with respect to the base member, and pivots around an axis of a pivoting apparatus formed in forward and backward directions of the monitor main body with respect to the link member.

The height of the monitor main body of the conventional monitor may be adjusted when tilting around the axes of the main body hinge and the base hinge.

However, the height of the monitor main body of the conventional monitor does not vary when the monitor main body is tilted; therefore, there is demand to be able to increase the height range of the monitor main body when the monitor main body is tilted. In addition, there is a need to reduce packaging size of the conventional monitor to reduce distribution and packaging costs.

### SUMMARY OF THE INVENTION

Accordingly, the present invention provides a monitor in which a monitor main body is adjusted in height with an increased height range.

Additional features of the invention will be set forth in the description which follows, and in part will be apparent from the description, or may be learned by practice of the invention.

The present invention discloses a monitor, including a main body to display an image, a base member coupled with the main body, a link member having a first end tiltably coupled with a main body hinge provided with respect to the main body and a second end tiltably coupled with a base hinge provided with respect to the base member, a main body bracket to tiltably couple the main body with the main body hinge, and a lifting unit provided between the main body and the main body bracket to support the main body when the main body is raised or lowered with respect to the main body bracket.

The present invention also discloses a monitor, including a main body to display an image, a base member coupled with the main body, a link member having a first end tiltably coupled with a main body hinge with respect to the main body and a second end tiltably coupled with a base hinge with respect to the base member, a main body bracket to tiltably couple the main body with the main body hinge, a pivoting unit to couple the monitor main body with the main body bracket so that the monitor main body pivots with respect to the main body bracket, a pivoting bracket to couple the monitor main body with the pivoting unit, and a lifting unit provided between the main body and the pivoting bracket, the lifting unit being coupled with the main body to enable the main body to be raised or lowered with respect to the pivoting bracket.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a rear perspective view of a monitor according to an embodiment of the invention.

FIG. 2 is a partial exploded perspective view of the monitor according to an embodiment of the invention.

FIG. 3 is an exploded perspective view of a lifting unit of the monitor according to an embodiment of the invention.

FIG. 4 is an exploded perspective view of a pivoting unit of the monitor according to an embodiment of the invention.

FIG. 5 is an exploded perspective view of a base hinge and a main body hinge of the monitor according to an embodiment of the invention.

FIG. 6a and FIG. 6b are lateral views showing a pivoting movement of a monitor main body of the monitor according to an embodiment of the invention.

FIG. 7 is a lateral view showing a tilting movement of the monitor main body of the monitor according to an embodiment of the invention.

FIG. 8a and FIG. 8b are lateral views showing a tilting movement of a link member of the monitor according to an embodiment of the invention.

FIG. 9 and FIG. 10 are lateral views of the monitor main body of the monitor according to an embodiment of the invention when it is folded to a base member.

FIG. 11 and FIG. 12 are lateral views showing lifting movement of the monitor main body of the monitor according to an embodiment of the invention.

### DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It is understood that when an element or layer is referred to as being “on” or “connected to” or “connected with” another element or layer, it can be directly on or directly connected to or with the other element or layer or intervening elements or layers may be present.

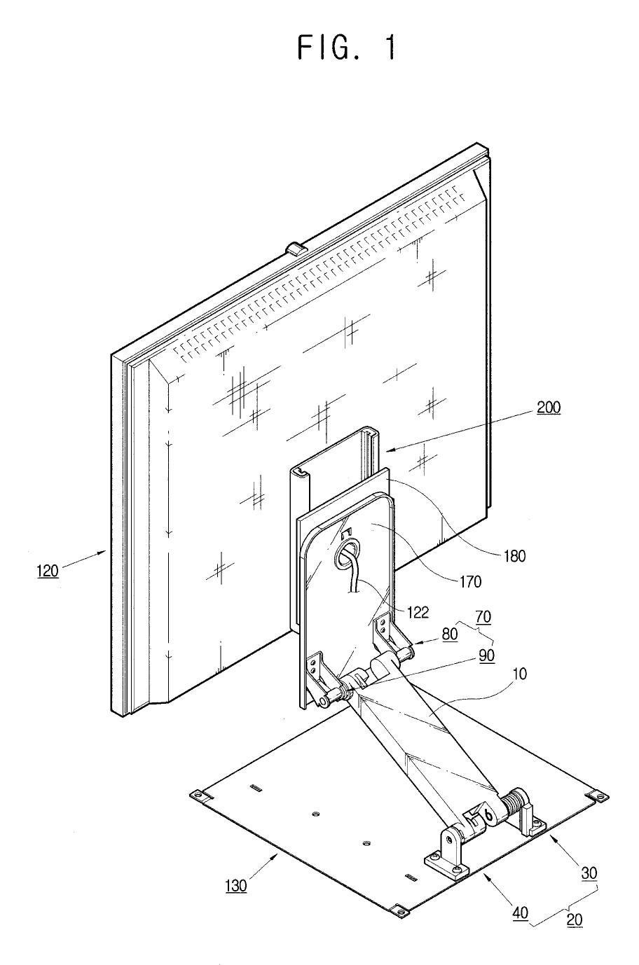

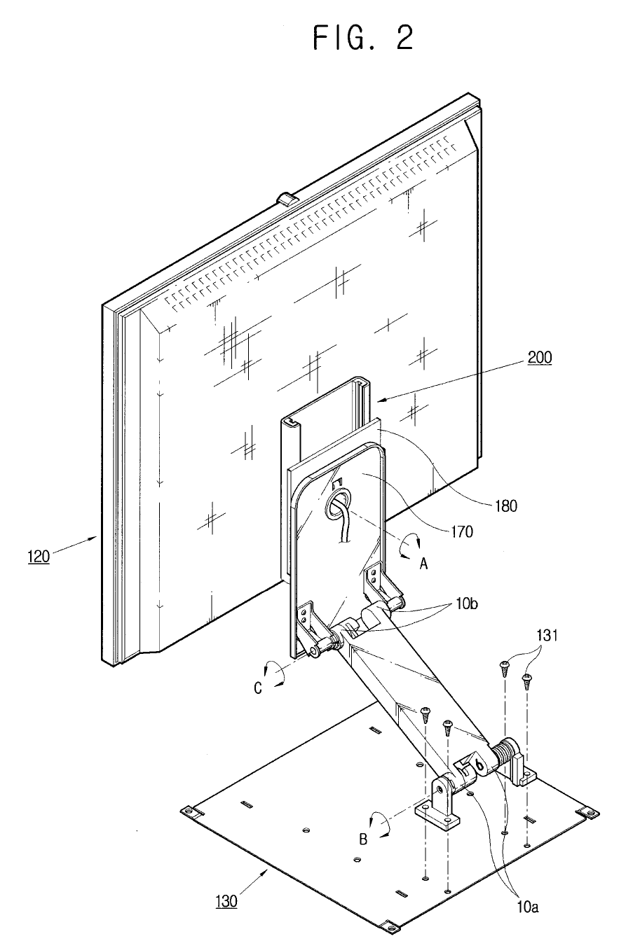

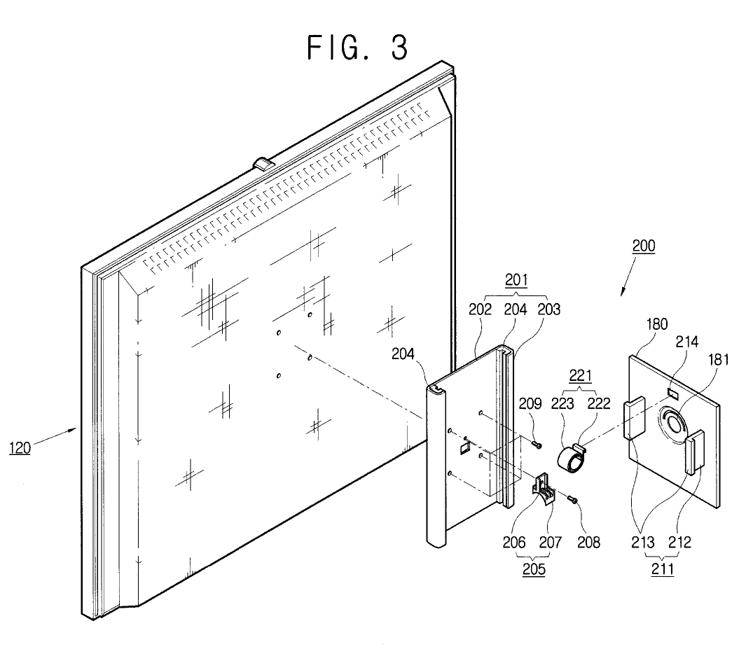

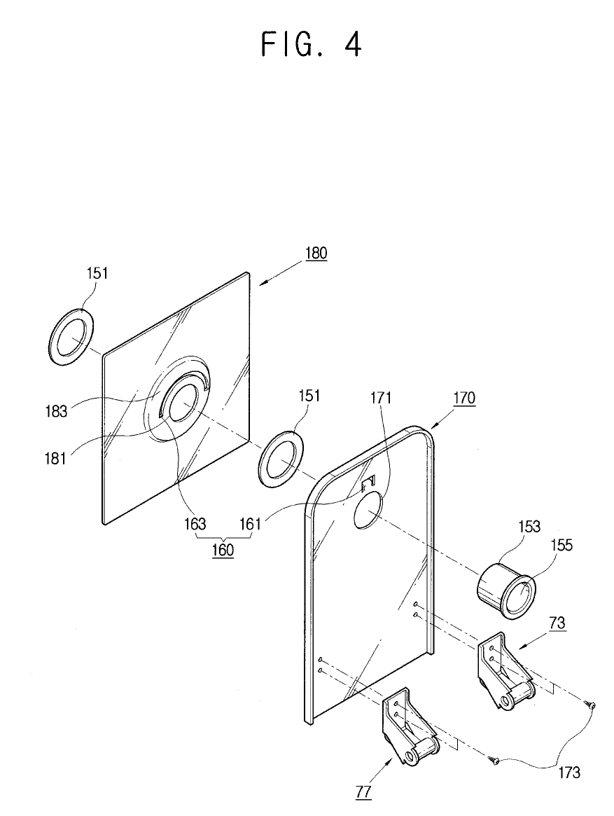

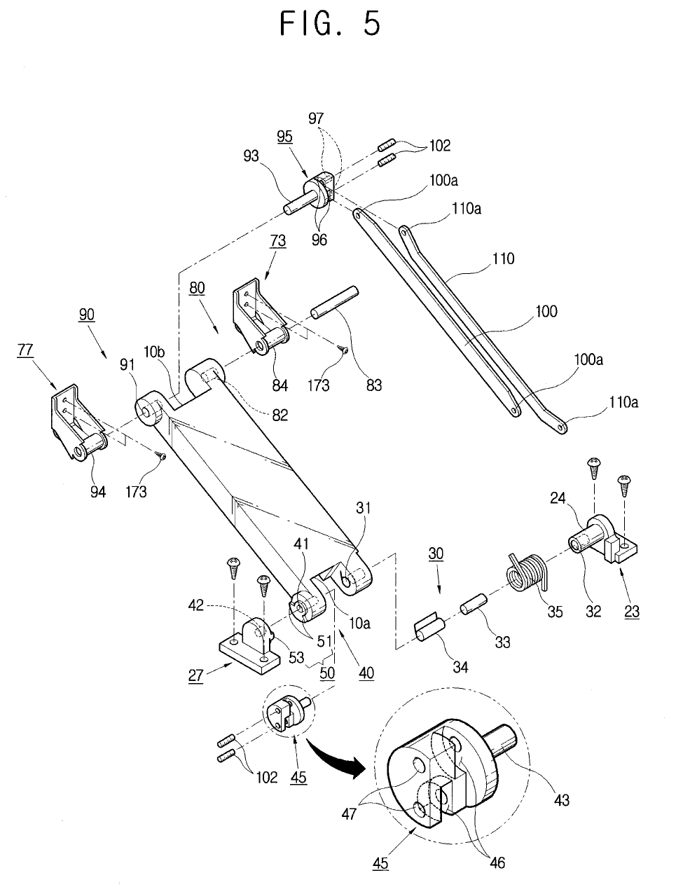

As shown in FIGS. 1, 2, 3, 4, and 5, a monitor according to the invention includes a monitor main body 120 to display a picture; a base member 130; a link member 10 having a first end tiltably coupled with a main body hinge 70 provided with respect to the monitor main body 120 and a second end tiltably coupled with a base hinge 20 provided with respect to the base member 130; a main body bracket 170 to tiltably connect, e.g., couple the monitor main body 120 with the main body hinge 70; and a lifting unit 200 that is provided between the monitor main body 120 and the main body bracket 170 to support the monitor main body 120 to move in a vertical direction, e.g., up and down, with respect to the main body bracket 170.

The monitor may further include a pivoting bracket 180 which is arranged between the lifting unit 200 and the main body bracket 170; and a pivoting unit 150 to connect, e.g., couple, the pivoting bracket 180 and the main body bracket 170 with pivot the monitor main body 120 with respect to the main body bracket 170.

The monitor may further include auxiliary link members 100 and 110 to transmit a tilting movement of the link member 10 with respect to the base member 130 to a tilting movement of the monitor main body 120 with respect to the link member 10.

The monitor may further include base support brackets 23 and 27 which are coupled with the base member 130 to be vertically, e.g., upwardly, extended; and main body support brackets 73 and 77 to be coupled with the main body bracket 170.

According to an embodiment of the invention, the monitor main body 120 may be mounted or attached with a flat display panel such as a liquid crystal display (LCD) or a plasma display panel (PDP) to display a picture. For purposes of convenience, the monitor main body 120 described below is mounted with an LCD panel.

The base member 130 may have a plate-like shape so that it may be seated on a predetermined surface, such as a desktop, and support the monitor main body 120.

The main body bracket 170 may have a plate-like shape. A pair of main body support brackets 73 and 77 are spaced apart and arranged on a first side of the main body bracket 170. The main body bracket 170 couples with a pivoting shaft 153 of the pivoting unit 150 (to be described later).

A pivoting bracket 180 may be arranged between the pivoting unit 150 and the lifting unit 200, and may have a plate-like shape. A first side of the pivoting bracket 180 faces the main body bracket 170 and couples with the pivoting shaft 153 of the pivoting unit 150 (to be described later) to pivot with respect to the main body bracket 170. A second side of the pivoting bracket 180 may be provided with a guide member 211 of the lifting unit 200 (to be described later).

The pivoting unit 150 connects, e.g., couples, the pivoting bracket 180 and the main body bracket 170 so that the pivoting bracket 180 may pivot around a pivoting axis (A), e.g., pivoting, in forward and backward directions, of the main body bracket 170. The pivoting unit 150 includes the pivoting shaft 153 to couple the main body bracket 170 with the pivoting bracket 180 to pivot each other with a predetermined friction force. The pivoting unit 150 includes a first penetrating part 171 that penetrates a first part of a plate surface of the main body bracket 170 to accommodate the pivoting shaft 153; and a second penetrating part 181 that penetrates a first part of a plate surface of the pivoting bracket 180. The pivoting unit 150 may further include a plurality of washers 151 arranged in the pivoting shaft 153 to provide a predetermined rotational friction force between the pivoting bracket 180 and the main body bracket 170.

The first penetrating part 171 penetrates on the plate surface of the main body bracket 170. The first penetrating part 171 has a circular-like shape with a predetermined diameter. The second penetrating part 181 is arranged on a bending part 183 that is bent on a substantially central part of the plate surface of the pivoting bracket 180 at a direction toward the main body bracket 170. Similar to the first penetrating part 171, the second penetrating part 181 is has a circular-like shape corresponding to the first penetrating part 171.

The pivoting shaft 153 has a cylinder-like shape so that it may penetrate the first penetrating part 171 and second penetrating part 181 and the plurality of washers 151. Opposite ends of the pivoting shaft 153 penetrate the first penetrating part 171 and the second penetrating part 181 and the plurality of washers 151 and press and apply to the pivoting bracket 180 and the main body bracket 170 a predetermined rotational friction force, and then are bent in a radial direction. A cable accommodating hole 155 is arranged at the pivoting shaft 153 to accommodate a cable 122 which connects the main body 120 with the base member 130 in a lengthwise direction of the pivoting shaft 153. The cable accommodating hole 155 may be a thru-hole.

The pivoting unit 150 may be provided with a pivoting angle limiter 160 to limit a pivoting angle of the pivoting bracket 180 with respect to the main body bracket 170.

The pivoting angle limiter 160 includes a pivot projection 161 which extends from the plate surface of the main body bracket 170 that includes the first penetrating part 171; and a slot 163 having a circular arc-like shape on the plate surface of the pivoting bracket 180 provided with the second penetrating part 181 to receive the pivot projection 161 thereby limiting or reducing the pivoting angle of the pivot projection 161.

The pivot projection 161 is formed, e.g., cut and bent, from the plate surface of the main body bracket 170 provided on an upper region of the first penetrating part 171. The slot 163 is formed on the plate surface of the pivoting bracket 180, which is spaced apart from the second penetrating part 181 at a predetermined distance, as a circular arc-like shape, to receive the pivot projection 161, thereby limiting or reducing the pivoting angle of the pivot projection 161.

According to an embodiment of the invention, the pivoting angle of the main body 120 is substantially 90° in leftward and rightward directions, respectively. Alternatively, the pivoting angle of the main body 120 may be substantially 90° or substantially 180° in a leftward or rightward direction as necessary.

In the embodiment shown in FIGS. 1,2,3,4, or 5, the pivot projection 161 is arranged on the main body bracket 170 and the slot 163 is arranged in the pivoting bracket 180. Alternatively, the pivot projection 161 may be arranged on the pivoting bracket 180, and the slot 163 may be arranged in the main body bracket 170.

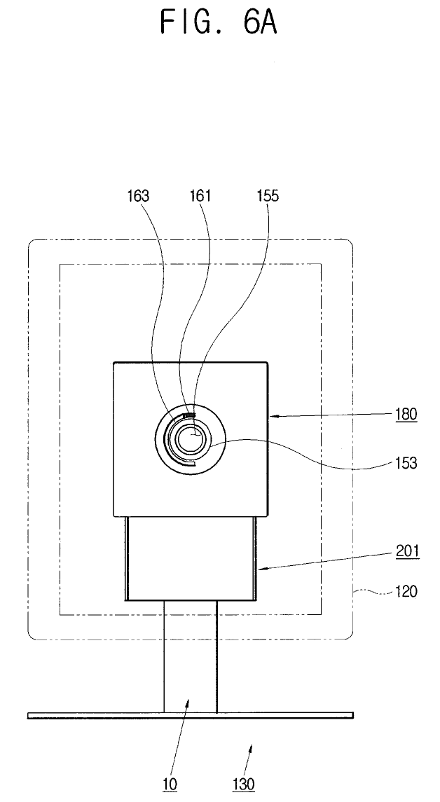

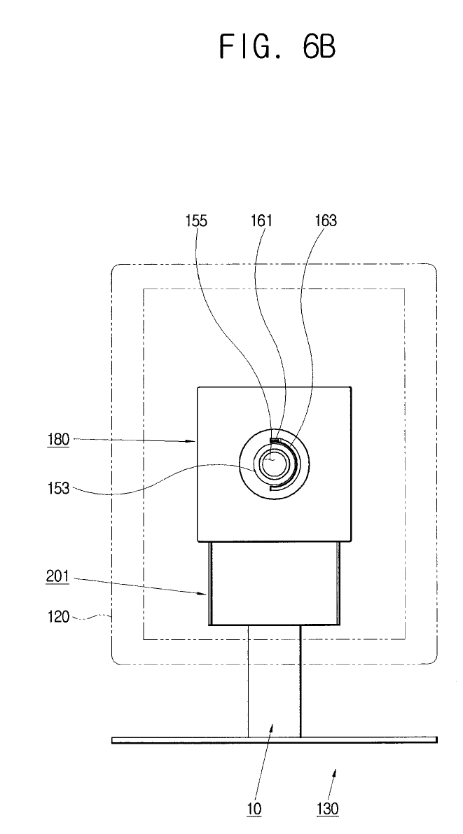

As shown in FIG. 6a and FIG. 6b, the main body 120 may pivot with respect to the main body bracket 170. For example, the pivoting bracket 180 coupled with the main body 120 may pivot around the pivoting axis (A) of the pivoting shaft 153 with respect to the main body bracket 170.

The base support brackets 23 and 27 includes a first base support bracket 23 and a second base support bracket 27, paired together, which are spaced apart and arranged on the base member 130. The base support brackets 23 and 27 may be coupled with the base member 130 by a fastening device, such as a screw 131.

The base hinge 20 includes base hinge shafts 33 and 43 to tiltably couple a lower end 10a of the link member 10 with the base support brackets 23 and 27. The base hinge 20 is provided in the base support brackets 23 and 27 to support the base hinge shafts 33 and 43, and further includes a base link support 45 to tiltably support the auxiliary link members 100 and 110 to be eccentric to a tilting axis (B) of the base hinge shafts 33 and 43.

According to an embodiment of the invention, the base hinge 20 may include a first base hinge 30 and a second base hinge 40 that together tiltably couple opposite ends of the lower end 10a of the link member 10 to the first base support bracket 23 and second base support bracket 27, respectively.

The first base hinge 30 includes a first base shaft accommodator 31 which penetrates on a first side of the lower end 10a of the link member 10 and has a circular-like shape, a first base shaft fixer 32 coupled with and inverted into the first base support bracket 23; a first base hinge shaft 33 having a first end which may be tiltably inserted into the first base shaft accommodator 31 and a second end which may be press fitted to the first base shaft fixer 32 so that it does not tilt; and a base friction spring 34 which is arranged between the first base shaft accommodator 31 and a first end of the first base hinge shaft 33 to provide friction force that is resistant to the tilting of the first base hinge shaft 33.

The base friction spring 34 may have a leaf spring-like shape having such that a first side may be press fitted with a first end of the first base hinge shaft 33 inserted to the first base shaft accommodator 31 and a second side which is coupled to the first side of the first base shaft accommodator 31. Thus, the base friction spring 34 integrally coupled with the link member 10 and the first base hinge shaft 33 integrally coupled to the base support bracket 23 are tiltably coupled with each other with predetermined friction force. Preferably, the predetermined friction force is sufficiently strong to prevent the link member 10 from tilting due to the -weight of the monitor main body 120 and the link member 10.

A spring support 24 extends from the internal end of the first base support bracket 23. A coil spring 35 is provided in the spring support 24 to elastically bias in a direction that is opposite to a direction that the link member 10 downwardly pivots toward the plate surface of the base member 130.

The coil spring 35 may be a torsion coil spring. A first side of the coil spring 35 is supported by the first base support bracket 23, and a second side thereof is supported by the link member 10 and has elastic force to press in an opposite direction of a forward tilting of the link member 10. The elastic force of the coil spring 35 is preferably similar to a force generated when the link member 10 is tilted forward by the weight of the main body 120. Thus, the weight of the main body 120 is offset by the elastic force of the coil spring 35 and a user may easily tilt the link member 10 with respect to the base member 130. Also, when forwardly or backwardly tilting the link member 10 with respect to the base member 130, the link member 10 may be tilted by pressing the link member 10 with about the same force as needed to overcome the friction force needs, which is generated between the base friction spring 34 and the first base hinge shaft 33.

The second base hinge 40 includes a second base shaft accommodator 41 that penetrates a second side of the lower end 10a of the link member 10, as a circle; a second base shaft fixer 42 arranged in the internal end of the second base support bracket 27; a second base hinge shaft 43 inserted into the second base shaft accommodator 41 to be tilted and has a first side that is press fit into the second base shaft fixer 42 not to tilt; and a base link support 45 that is integrated with the second side of the second base hinge shaft 43.

The base link support 45 is provided at an internal surface of the second side of the lower end 10a of the link member 10, and is integral with the second base hinge shaft 43 that is press fit into the second base shaft fixer 42 of the second base support bracket 27. Accordingly, the base link support 45 is integrally coupled with the second base support bracket 27 connected with the second base hinge shaft 43 not to tilt. The second base shaft accommodator 41 of the link member 10 is tiltably coupled with the second base hinge shaft 43.

A tilting angle limiter 50 is provided in the second base hinge 40 to limit a tilting angle of the link member 10 with respect to the base member 130.

The tilting angle limiter 50 makes the link member 10 tilt within a predetermined tilting angle range with respect to the base member 130. For example, the tilting angle of the link member 10 may be in the range of about 0° to about 180°.

Therefore, the present invention may include the tilting angle limiter 50 having a pair of radiation cutters 51 that are radiantly cut to face each other on the second side of the lower end 10a of the link member 10, having a space therebetween; and a projection 53 that is selectively held and maintained to the respective radiation cutters 51 along a tilting direction of the link member 10 in the internal end of the second base support bracket 27.

The radiation cutters 51 may be spaced apart at a predetermined distance from each other to enable the projection 53 tilt around 180°. Thus, the link member 10 may tilt around 180° with respect to the base member 130 around the base hinge shafts 33 and 43 to be forwardly and backwardly folded with respect to the base member 130.

The main body support brackets 73 and 77 are arranged on the main body bracket 170 as the first main body support bracket 73 and the second main body support bracket 77, leaving a predetermined space between each other. A first side of the main body support brackets 73 and 77 is coupled with a lower part of the main body bracket 170 by a fastening device, such as a screw 173, and a second side thereof includes main body friction springs 84 and 94 that may be shaped like a leaf spring, and accommodate the main body hinge shafts 83 and 93 (to be described later) to be tiltably coupled with predetermined friction force.

The main body hinge 70 includes the main body hinge shafts 83 and 93 to tiltably couple an upper end 10b of the link member 10 with the main body support brackets 73 and 77 with a predetermined friction force. The main body hinge 70 further includes a main body link support 95 that faces the main body support bracket 73 and 77, leaving the main body hinge shaft 83 and 93 therebetween, to support the main body hinge shafts 83 and 93, and tiltably support the auxiliary link members 100 and 110 to be eccentric to an axis of the main body hinge shafts 83 and 93.

The main body hinge 70 includes a first main body hinge 80 and a second main body hinge 90 to tiltably couple opposite ends of the upper end 10b of the link member 10 with the main body support brackets 73 and 77, respectively.

The first main body hinge 80 includes a main body shaft fixer 82 that is arranged on a first side of the upper end 10b of the link member 10; a first main body hinge shaft 83 having a first end that is press fit into the main body shaft fixer 82 so as not to tilt; and a first main body friction spring 84 that is tiltably coupled with a second end of the first main body hinge shaft 83 and integral with the first main body support bracket 73 to provide a friction force sufficient to resist the tilting of the first main body hinge shaft 83. Thus, the first main body hinge shaft 83 is press fit into the main body shaft fixer 82 of the link member 10 so as not to tilt and also tiltably inserted into the first main body friction spring 84 that is integral with the first main body support bracket 73 with a predetermined friction force.

The second main body hinge 90 includes a main body shaft accommodator 91 that penetrates a second side of the upper end 10b of the link member 10 in a circular-like shape, a main body link support 95 that is provided in an internal surface of the main body shaft accommodator 91; a second main body hinge shaft 93 inserted into the main body shaft accommodator 91 to be tilted and having a first end integrally formed with the main body link support 95; and a second main body friction spring 94 tiltably coupled with the second end of the second main body hinge shaft 93 and integral with the second main body support bracket 77 to provide friction force sufficiently resistant to the tilting of the second main body hinge shaft 93.

The second main body hinge shaft 93 is tiltably and inserted into the main body shaft accommodator 91 of the link member 10 and tiltably inserted into the second main body friction spring 94 that is integral with the second main body support bracket 77 with a predetermined friction force.

Thus, the main body hinge shafts 83 and 93 may support the main body bracket 170 and the link member 10 to allow the main body bracket 170 to tilt around 180°, e.g., from an angle where the main body bracket 170 is folded to the link member 10 to an angle where the main body bracket 170 is unfolded in a lengthwise direction of the link member 10.

The main body link support 95 is provided in an internal surface of the second side of the upper end 10b of the link member 10, and integrally formed with the second main body hinge shaft 93. As the main body link support 95 and the base link support 45 are coupled with each other by the auxiliary link members 100 and 110, the main body link support 95 is tilted by the auxiliary link members 100 and 110. When the auxiliary link members 100 and 110 and the link member 10 do not tilt and the monitor main body 120 tilts with respect to the link member 10, the main body bracket 170 tilts around a tilting axis (C) of the first main body hinge shaft 83 and the second main body hinge shaft 93 by overcoming a rotational friction force of the first main body friction spring 84 and the second main body friction spring 94. The friction force between the first main body hinge shaft 83 and the first main body friction spring 84 and between the second main body hinge shaft 93 and the second main body friction spring 94 is preferably greater than a force through which the monitor main body 120 tilts due to its own weight.

The auxiliary link members 100 and 110 each have a bar-like shape and are accommodated in the link member 10. The auxiliary link members 100 and 110 are tiltably coupled with the base link support 45 and the main body link support 95. Auxiliary link accommodators 46 and 96 that are inserted with opposite ends of the auxiliary link member 100 and 110, having a predetermined space between each other, are formed in the base link support 45 and the main body link support 95. A plurality of pin insertion holes 47 and 97 that communicate with the auxiliary link accommodators 46 and 96 are formed in the base link support 45 and the main body link support 95. When penetrating holes 100a and 110a of the auxiliary link members 100 and 110 and pin insertion holes 47 and 97 of the base link support 45 and the main body link support 95 communicate with each other by inserting the penetrating holes 100a and 110a into the auxiliary link accommodators 46 and 96 , the auxiliary link members 100 and 110 may be installed by coupling the penetrating holes 100a and 110a and the pin insertion holes 47 and 97 through a plurality of link coupling pins 102 so that they move substantially in parallel with each other.

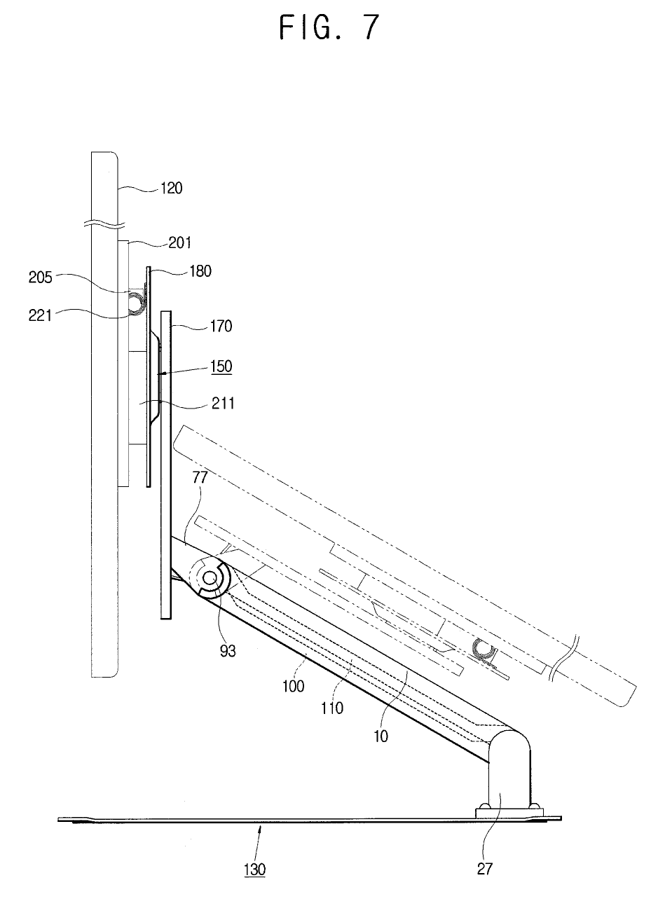

According to the above configuration, the tilting process of the link member 10 and the main body 120 of the monitor according to the invention are described below with reference to FIGS. 7 to 10.

The link member 10 may tilt around the tilting axis (B), e.g., at leftward and rightward directions at the base hinge shafts 33 and 43 with respect to the plate surface of the base member 130. The main body 120 may independently tilt around the tilting axis (C), e.g., at leftward and rightward directions, of the main body hinge shafts 83 and 93 with respect to the link member 10, without tilting the link member 10.

As shown in FIG. 7, when the main body 120 is pressed forward or backward, the main body 120 overcomes the tilting friction force and tilts around the tilting axis (C) of the main body hinge shaft 83. The main body 120 may tilt backwards with respect to the link member 10 to be folded to the place surface of the link member 10, and may tilt forward with respect to the link member 10 so that it is parallel with the lengthwise direction of the link member 10.

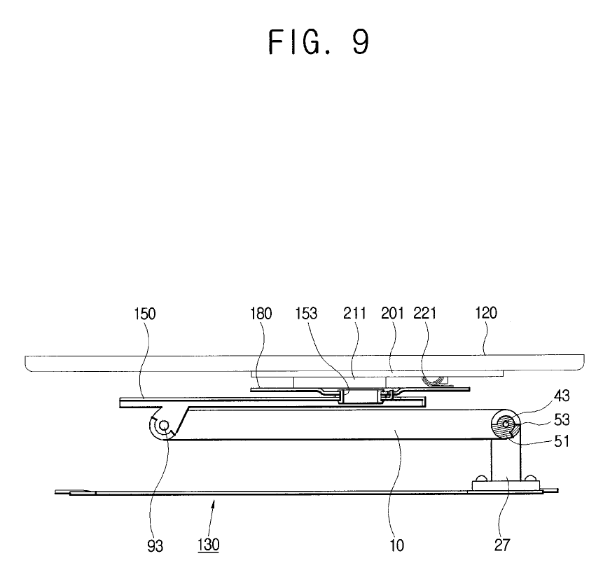

As shown in FIG. 9, the main body 120 may be folded in parallel with the plate surface of the base member 130 in an upper part of the link member 10.

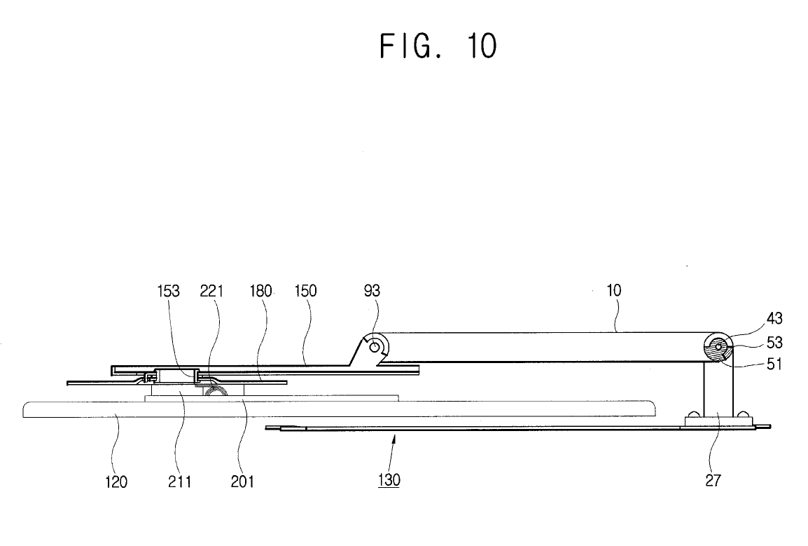

As shown in FIG. 10, when the main body 120 is tilted in parallel with the lengthwise direction of the link member 10, the link member 10 forwardly tilts in parallel with the base member 130, thereby disposing the main body 120 between the base member 130 and the link member 10 to be folded with the plate surface of the base member 130. According to the above embodiments, the monitor may reduce packaging size by folding the monitor main body 120 to be parallel with the base member 130.

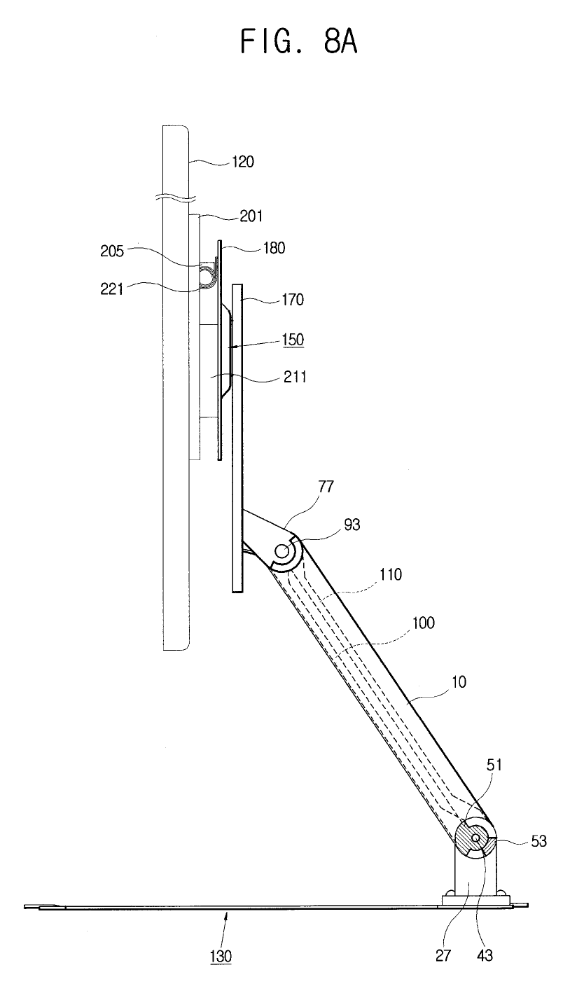

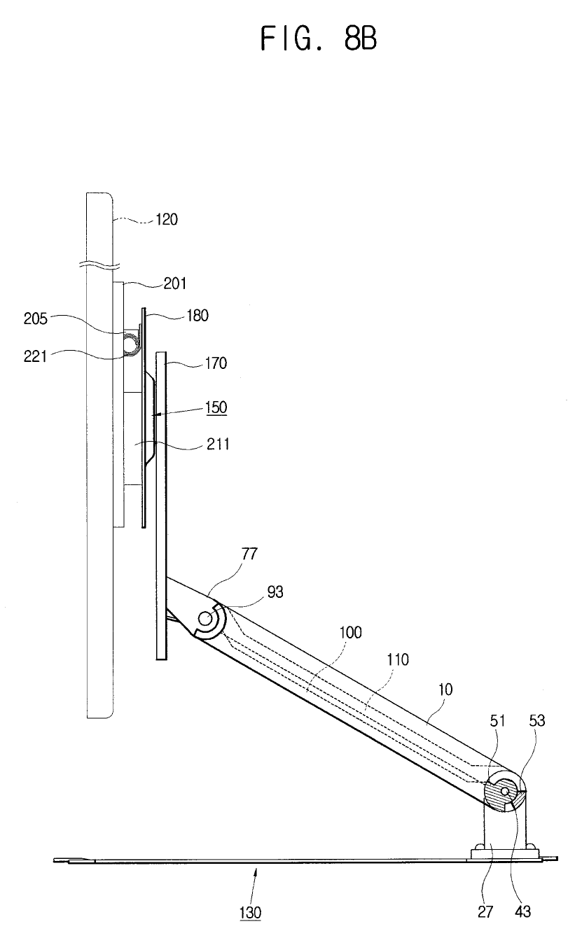

Instead of tilting independently, the monitor main body 120 may be titled by the auxiliary link members 100 and 110 by moving with the tilting of the link member 10 with respect to the plate surface of the base member 130. As shown in FIG. 8a and FIG. 8b, when the link member 10 forwardly tilts with respect to the base member 130, the main body link support 95 provided in the upper end 10b of the link member 10 tilts clockwise at a predetermined angle by the auxiliary link members 100 and 110. The tilting of the main body link support 95 is transmitted to the second main body hinge shaft 93. The second main body hinge shaft 93 and the second main body support bracket 77 tilt the main body 120 at a predetermined angle. As the second main body hinge shaft 93 and the second main body friction spring 94 of the second main body support bracket 77 have predetermined friction force, the second main body hinge shaft 93 and the second main body support bracket 77 tilt integrally. Thus, the main body 120 tilts the link member 10 with respect to the base member 130 to adjust a height thereof. Also, the monitor main body 120 may be tilted by moving together with the tilting of the link member 10 with respect to the base member 130, thereby maintaining the viewing angle of the monitor main body 120.

The process of tilting the link member 10 backwards is similar to the foregoing process therefore it is not discussed for purposes of convenience.

The lifting unit 200 includes a lifting member 201 coupled with the main body 120; and a guide member 211 coupled with the main body bracket 170 to slideably support the lifting member 201 in a vertical direction, e.g., upward and downward directions. The lifting unit 200 is provided between the guide member 211 and the lifting member 201. The lifting unit 200 may further include an elastic member 221 to press, e.g., press, the lifting member 201 with respect to the guide member 211. The lifting unit 200 may further include a sliding member 204 composed of soft material and provided between the guide member 211 and the lifting member 201.

The lifting member 201 is depressed vertically, e.g., in upward and downward directions, of the monitor main body 120 to accommodate the guide member 211. The lifting member 201 may be coupled with a back of the main body 120. The lifting member 201 includes a lifting main body 202 that is coupled with the monitor main body 120; and a guide accommodator 203 to accommodate the guide member 211 on opposite sides of the lifting main body 202.

The lifting main body 202 may be shaped like a plate, and is coupled with a rear surface of the main body 120 by a fastening device, such as screw 209, etc. An elastic member supporting member 205 may be provided in the lifting main body 202 to support the elastic member 221.

The guide accommodator 203 is arranged on opposite sides of the lifting main body 202 to accommodate and support the guide member 211. A cross section of the guide accommodator 203 may be shaped like “U” to accommodate and guide the guide member 67. The sliding member 204 is provided in the guide accommodator 203 to slide with the guide member 211.

The sliding member 204 may be composed of an acetal material. Alternatively, the sliding member 204 may be composed of any of various materials such as plastic, metal, etc. to slide the lifting member 201 with respect to the guide member 211.

As shown in FIGS. 7-8b, the guide member 211 is provided on a front surface of the pivoting bracket 180 and accommodated in the lifting member 201. The guide member 211 includes a pair of guide main bodies 212 forwardly extending from the pivoting bracket 180, and guides 213 bent from opposite ends of the guide main bodies 212 to be inserted to the guide accommodator 203.

The guide main bodies 212 may be provided on a front of the pivoting bracket 180 and extend vertically, e.g., in upward and downward directions. Alternatively, the guide main bodies 212 may be provided in the main body bracket 170 when the pivoting unit 150 is not provided in the present invention. The guide main bodies 212 are shorter than the lifting unit 201 so that they may be accommodated in the lifting unit 201 and they support the lifting unit 201 to lift it up and down.

A first side of the elastic member 221 is coupled with the guide member 211, and a second side thereof is formed therearound to press, e.g., upwardly press, the lifting member 201. The elastic member 221 may be shaped like a spiral spring. The elastic member 221 includes a spring coupler 222 which is provided on a first side thereof to be coupled with the guide member 211 or the pivoting bracket 180; and a coil 223 which is provided on a second side thereof and formed like a roll. For example, one elastic member may be provided as the elastic member 221. Alternatively, a plurality of elastic members may be provided. It is understood that the elastic member 221 may be provided as a coil spring, a leaf spring or an elastic body such as rubber material.

According to an embodiment of the invention, the spring coupler 222 is coupled with a spring support 214 which is provided in the pivoting bracket 180. Alternatively, the spring coupler 222 may be coupled with the guide main bodies 212 of the guide member 211. When the pivoting unit 150 is not provided, the spring coupler 222 may be coupled with the main body bracket 170.

The coil 223 is supported by the elastic member supporting member 205 provided in the lifting member 201 to press, e.g., upwardly press, the lifting member 201. Specifically, the coil 223 may be arranged on a lower part of the elastic member supporting member 205 to press, e.g., upwardly press, the elastic member 221. The elastic force of the coil 223 is preferably strong enough to prevent the monitor main body 120 from moving downward due to its own weight. That is, the elastic force of the coil 223 is similar to the self-weight of the monitor main body 120. Thus, a main body 120 may be lifted up and/or down by the elastic force of the coil 223.

The elastic member supporting member 205 includes a support member coupler 206 provided on a first side thereof to be coupled with the lifting member 201 via a fastening device, e.g., the screw 208; and a support member contactor 207 which is provided on a second side thereof and having a circular shape to contact an upper part of the coil 223.

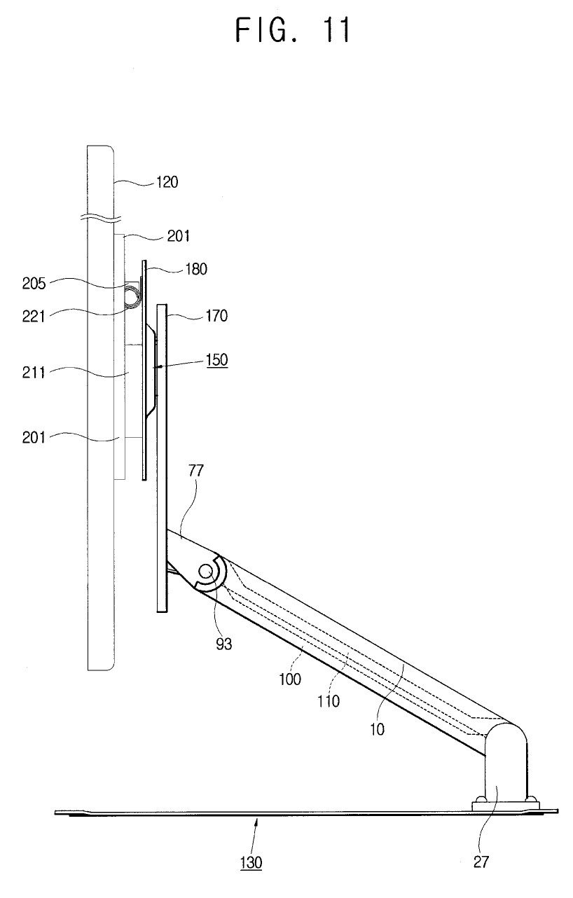

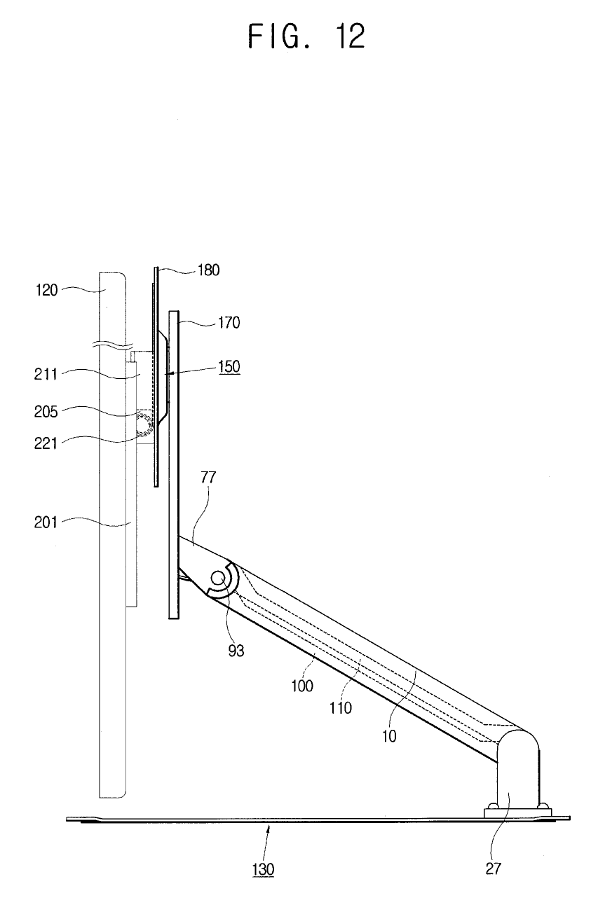

According to the above described configuration, the main body 120 of the monitor is lifted with respect to the pivoting bracket 180 or the main body bracket 170 by the lifting unit 200, as shown in FIG. 11 and FIG. 12. The lifting height of the monitor main body 120 is determined by the length of the lifting member 201 with respect to the guide member 211. For example, when the lifting member 201 is vertically elongated with respect to the guide member 211, the height of lifting the monitor main body 120 may be increased.

Thus, according to the present invention, the main body 120 may be lifted by the tilting of the link member 10 and by the lifting unit 200, thereby increasing the height range of the main body 120.

Also, the monitor of the present invention is described so as to reduce a packaging size as well as maintain a viewing angle of the main body when the height of the main body is adjusted.

Although the coil spring is discussed and shown as being provided in the base hinge, the coil spring may instead be provided in the main body hinge.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A monitor, comprising:
a main body to display an image;
a base member coupled with the main body;
a link member having a first end tiltably coupled with a main body hinge provided with respect to the main body and a second end tiltably coupled with a base hinge provided with respect to the base member;
a main body bracket to tiltably couple the main body with the main body hinge; and
a lifting unit provided between the main body and the main body bracket to support the main body when the main body is raised or lowered with respect to the main body bracket.

2. The monitor of claim 1, wherein the lifting unit comprises:
a lifting member provided on the main body; and
a guide member coupled with the main body bracket to slideably support the lifting member when the lifting unit is raised or lowered.

3. The monitor of claim 2, further comprising:
an elastic member arranged between the guide member and the lifting member to press the lifting member with respect to the guide member.

4. The monitor of claim 3, wherein the elastic member comprises:
a spiral spring having a first side coupled with the guide member and a second side shaped such that it presses the lifting member.

5. The monitor of claim 2, further comprising:
a pivoting bracket arranged between the lifting unit and the main body bracket; and
a pivoting unit to couple the pivoting bracket with the main body bracket so that the main body pivots with respect to the main body bracket.

6. The monitor of claim 5, wherein the pivoting unit comprises:
a pivoting shaft to couple the main body bracket with the pivoting bracket, the pivoting shaft having a cable accommodating hole that accommodate a cable to couple the main body with the base member.

7. The monitor of claim 6, wherein the pivoting unit comprises:
a pivoting angle limiter to limit a pivoting angle of the pivoting bracket with respect to the main body bracket.

8. The monitor of claim 1, further comprising:
an auxiliary link member coupled with the main body hinge and the base hinge at a position that is eccentric to axes of the main body hinge and the base hinge to transmit a tilting movement of the link member with respect to the base member to a tilting movement of the main body with respect to the link member around the axis of the main body hinge.

9. The monitor of claim 8, further comprising:
a base support bracket coupled with the base member and extending therefrom, wherein the base hinge comprises a base hinge shaft that tiltably couples a lower end of the link member with the base support bracket.

10. The monitor of claim 9, further comprising:
a main body support bracket coupled with the main body bracket, wherein the main body hinge comprises a main body hinge shaft to tiltably couple an upper end of the link member with the main body support bracket.

11. The monitor of claim 10, wherein the base hinge further comprises a base link support provided in the base support bracket to support the base hinge shaft and tiltably support the auxiliary link member so that it is eccentric to the axis of the base hinge shaft; and
wherein the main body hinge further comprises a main body link support facing the main body support bracket to support the main body hinge shaft provided therebetween and to tiltably support the auxiliary link member so that the auxiliary link member is eccentric to the axis of the main body hinge shaft.

12. The monitor of claim 1, wherein the link member forwardly tilts around a tilting axis of the base hinge and is folded to be substantially parallel with a plate surface of the base member such that the main body is disposed between the base member and the link member and is folded to be substantially parallel with the plate surface of the base member.

13. A monitor, comprising:
a main body to display an image;
a base member coupled with the main body;
a link member having a first end tiltably coupled with a main body hinge with respect to the main body and a second end tiltably coupled with a base hinge with respect to the base member;
a main body bracket to tiltably couple the main body with the main body hinge;
a pivoting unit to couple the monitor main body with the main body bracket so that the monitor main body pivots with respect to the main body bracket;
a pivoting bracket to couple the monitor main body with the pivoting unit; and
a lifting unit provided between the main body and the pivoting bracket, the lifting unit being coupled with the main body to enable the main body to be raised or lowered with respect to the pivoting bracket.

14. The monitor of claim 13, wherein the lifting unit comprises:
a guide member that is vertically disposed with respect to the pivoting bracket, and
a lifting member that is coupled with the main body and slides along the guide member.

15. The monitor of claim 14, further comprising:
an elastic member arranged between the guide member and the lifting member to press the lifting member with respect to the guide member.

16. The monitor of claim 15, further comprising:
an auxiliary link member coupled with the main body hinge and the base hinge at a position that is eccentric to axes of the main body hinge and the base hinge to transmit a tilting movement of the link member with respect to the base member to a tilting movement of the main body with respect to the link member around the axis of the main body hinge.

17. The monitor of claim 16, further comprising:
a base support bracket coupled with the base member and extending therefrom, wherein the base hinge comprises a base hinge shaft to tiltably couple a lower end of the link member with the base support bracket.

18. The monitor of claim 17, further comprising:
a main body support bracket coupled with the main body bracket, wherein the main body hinge comprises a main body hinge shaft to tiltably couple an upper end of the link member with the main body support bracket.

19. The monitor of claim 18, wherein the base hinge further comprises a base link support provided in the base support bracket to support the base hinge shaft and tiltably support the auxiliary link member such that it is eccentric to the axis of the base hinge shaft; and
wherein the main body hinge further comprises a main body link support facing the main body support bracket to support the main body hinge shaft that is provided therebetween and to tiltably support the auxiliary link member so that the auxiliary link member is eccentric to the axis of the main body hinge shaft.
